(19) United States
(12) Patent Application Publication
(10) Pub. No.: US 2005/0206639 A1
(43) Pub. Date: Sep. 22, 2005

(54) Safety and protective personal computer power supply display device

(76) Inventor: Nelson Chen, Taipei City (TW)

Correspondence Address: Sirtec International Co., Ltd., P.O. Box No. 6-57, Junghe, Taipei, 235, TW

(21) Appl. No.: 10/801,666

(22) Filed: Mar. 17, 2004

(51) Int. Cl. G09G 5/00

(52) U.S. Cl. 345/211

(57) ABSTRACT

A safety and protective personal computer power supply display device for usage in a power supply attached to a personal computer, and which comprises at least a display unit embedded in a case of or externally connected to the original power supply, and enabled to display status of the original power supply; a processing unit configured within the case of the original power supply, and which can read status of the original power supply, including power loss, power consumption, voltage, and so on; and a power supply unit electrically connected to the processing unit. Wherein detection and control from the processing unit, and display of pertinent information on the display unit allow an understanding of status of related working power supply of the original power supply, thereby realizing early response preparation, and further enhancing protective function of the original power supply, lowering probability of malfunction and reducing maintenance costs.

### BACKGROUND OF THE INVENTION

(a) Field of the Invention

The present invention relates to a safety and protective personal computer power supply display device, and more particularly to the power supply display device for usage in a personal computer device, therewith providing an understanding of status of working power supply, and realizing early response preparation, thereby lowering probability of malfunction and reducing maintenance costs.

(b) Description of the Prior Art

A conventional personal computer power supply is designed for purpose of providing corresponding power supply for operation of the personal computer. However, during course of operation of the personal computer, all associated power supply is provided by the power supply of the computer, and when additional functions are added to the computer, specifications of the power supply must be correspondingly updated in order to maintain compatibility.

Whenever any new power supply was introduced, a common objective desired of forerunners of present electronic technology related power supplies was to how to effectively achieve enhancement in protective functionality of the power supply and provide real time information to a user on operation of the power supply (for instance, information on rotating speed of fan, inner temperature, power consumption, and so on), and thereby lower probability of malfunction and reduce later maintenance costs,

With reference to prior power supply related devices, for instance, U.S. Pat. No. 6,665,197 filed by Infineon Technologies AG (Munich. DE), and having patent name “Circuit configuration for producing a switching signal for a current-controlled switch-mode Power Supply”; U.S. Pat. No. 6,665,183 filed by Sansha Electric Manufacturing Company, Limited (Osaka.JP), and having patent name “Power Supply apparatus”; and U.S. Pat. No. 6,665,176 filed by GE Medical Systems Global Technology Company, LLC (Waukesha Wis.), and having patent name “Electronic device”, wherein claims disclosed can be mostly classified as providing an improvement on the power supply device of old-style specifications.

Accordingly, structural design of the conventional power supply attached to the personal computer has at least the following shortcomings: inability to display power loss, power consumption, voltage measurement, and so on; the user is unable to accurately keep track of the status of the power supply, and thereby eliminate malfunctions in real time; and after occurrence of the malfunction, a maintenance engineer is unable to gain a thorough understanding of the malfunction. Basically, the conventional power supply is unable to unable to achieve objective of effectively reducing probability of malfunctioning and thereby minimize maintenance costs.

A great variety of shortcomings become apparent if further inquiries are made into practicability of structural configuration of the conventional power supply attached to the personal computer, wherein apart from aforementioned problems of stability in practical usage and rating, more specifically are problems resulting from difficulties for the maintenance engineer to locate cause of breakdown. Hence, imperfections of the conventional power supply as described indeed results in inability to achieve effective functionality.

### SUMMARY OF THE INVENTION

In light of aforementioned shortcomings of conventional art, a primary objective of the present invention is to provide a safety and protective personal computer power supply display device that is utilized to display status of original power supply, including power loss, power consumption, voltage measurement, and so on, thereby allowing a user to easily understand operation status of the power supply by means of a display unit, and thus enabling real time elimination of possible damage, and lowering of probability of malfunction.

Another objective of the present invention is to provide the safety and protective personal computer power supply display device, whereby the display unit displays pertinent information, thereby allowing an understanding of status of related working power supply, and realizing early response preparation, thus further enhancing protective function of the original power supply, and lengthening service life of the original power supply.

In order to achieve the aforementioned and other objectives, the present invention provides the personal computer power supply display device with safety and protective functionality, whereby the display device is applicable for usage in the power supply attached to the personal computer, and wherein the display device comprises: a display unit embedded in or externally connected to a case of the original power supply; a processing unit disposed within the case of the power supply; and a power supply unit electrically connected to the processing unit, therewith providing electrical power and pertinent information for a counter to read.

Wherein the display unit is connected to the processing unit for receiving information therefrom, whereby the processing unit is disposed within the case of the original power supply, thereby enabling the display unit to display the status of the original power supply on a screen thereof, accordingly allowing an understanding of status of related working power supply, and realizing early response preparation, thus further enhancing protective function of the original power supply, and lowering probability of malfunction, and therefore reducing maintenance costs.

Furthermore, the processing unit is provided with electricity from the power supply unit of the original power supply, and the counter as configured reads the status of the original power supply, including the power loss, the power consumption, the voltage measurement, and so on.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a general elevational schematic view of a safety and protective personal computer power supply display device according to the present invention.

FIG. 2 shows a general elevational schematic view of another embodiment of the safety and protective personal computer power supply display device according to the present invention.

FIG. 3 shows a configurational circuit block diagram according to the present invention.

FIG. 4 shows an operating flow chart according to the present invention.

### DETAILED DESCRIPTION OF THE PREFERRED EMBODIMENTS

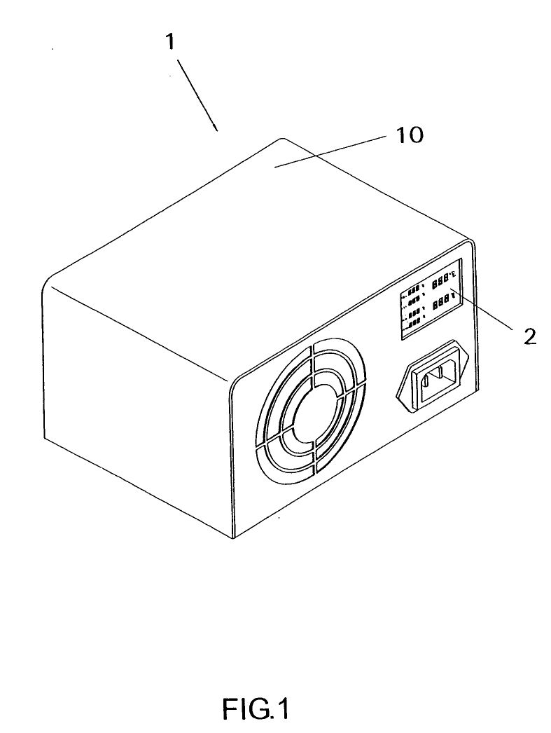

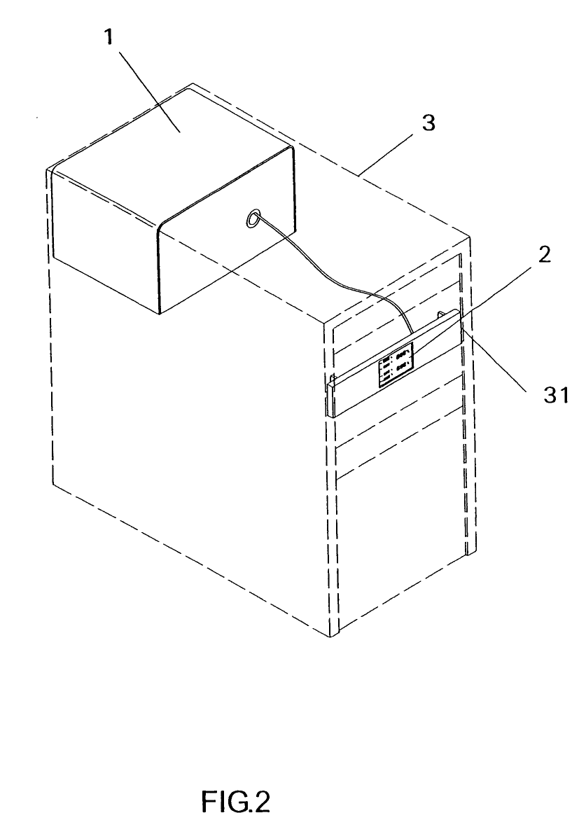

Referring to FIGS. 1 and 2, which show a general elevational schematic view of a safety and protective personal computer power supply display device and a general elevational schematic view of another embodiment of the present invention respectively. Wherein the display device comprises a display unit 2 utilized to display various functional states of the original power supply; and as depicted in FIG. 1, the display unit 2 can be configured so as to be embedded in a face of the original power supply 1; or as depicted in FIG. 2, the display unit 2 can also be externally electrically connected to the original power supply 1. Modular circuits and electronic devices having various functions are configured within a case 10 of the original power supply 1. An embed opening 31 is defined in a face of a computer case 30 of an original host computer 3, and which provides for disposing of the display unit 2 in the face of the computer case 30 of the host computer 3 therein.

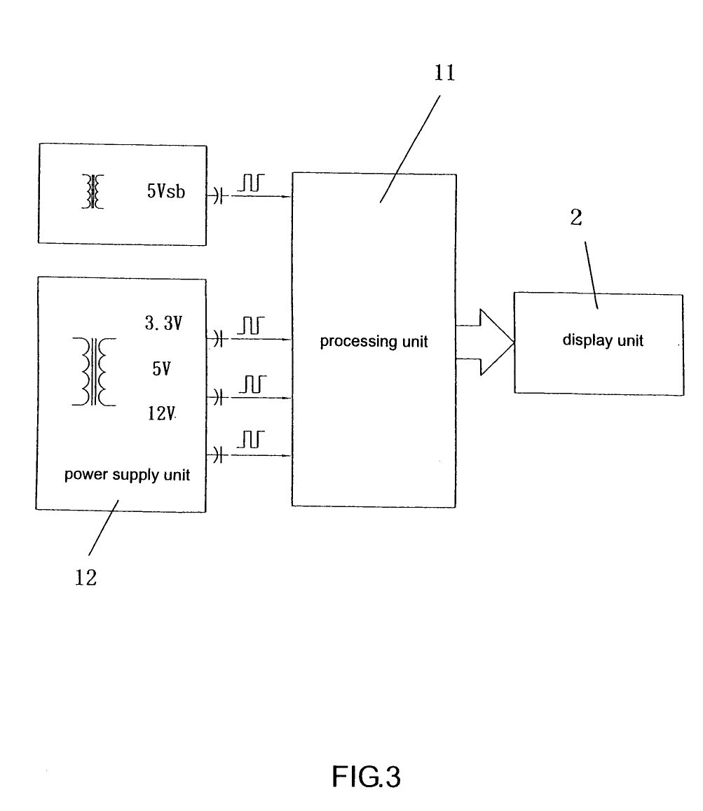

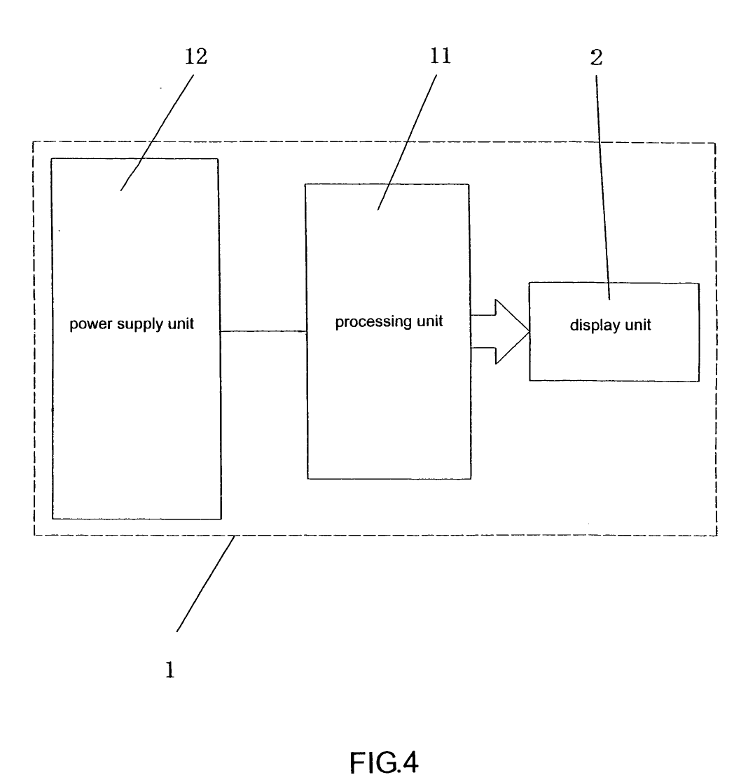

Referring to FIGS. 3 and 4, which show a configurational circuit block diagram, and an operating flow chart of the present invention respectively. Wherein the processing unit 11 is configured within the case 10 of the original power supply 1. One side of the processing unit 11 is electrically connected to the display unit 2, and another side of the processing unit 11 is electrically connected to a power supply unit 12. The processing unit 11 is further connected in series to an externally configured protective device 13 for receiving information therefrom. The processing unit 11 is thus enabled to receive pertinent information transmitted from the power supply unit 12 including power loss, power consumption, voltage measurement, and so on, and displays the information on the display unit 2 thereof.

In addition, the power supply unit 12 being electrically connected to the processing unit 11 functions to provide electrical power and related unit operations, while simultaneously providing information to the processing unit 11 as read by a counter.

The display unit 2 is enabled to display status of the original power supply, accordingly allowing an understanding of status of related working power supply, and realizing early response preparation, thus further enhancing protective function of the original power supply, and lowering probability of malfunction, and therefore reducing maintenance costs.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A safety and protective personal computer power supply display device applicable for usage in a power supply device of a personal computer; the display device comprising at least:
a power supply case, wherein are disposed modular circuits and electronic devices having various functions, an embed opening is defined in a face of a computer case of an original host computer, and which provides for disposing of a display unit in the face of a computer case of the host computer therein;
a display unit, which is utilized to display various functional states of the original power supply, whereby the display unit can be configured so as to be embedded in a face of the original power supply, moreover, the display unit can also be externally electrically connected to the original power supply;
a processing unit, which is configured within the case of the original power supply, wherein one side of the processing unit is electrically connected to the display init, and another side of the processing unit is electrically connected to a power supply unit; and the power supply unit, which is electrically connected to the processing unit, and utilized to provide electrical power and related unit operations, and moreover, simultaneously provides pertinent information to the processing unit as read by a counter.

2. The safety and protective personal computer power supply display device according to claim 1, wherein the processing unit receives pertinent information transmitted from the power supply unit on power loss, power consumption, voltage measurement, and so on, and displays the information on the display unit thereof.
